(19) United States
(12) Patent Application Publication
(10) Pub. No.: US 2017/0187910 A1
(43) Pub. Date: Jun. 29, 2017

(54) METHOD, APPARATUS, AND COMPUTER-READABLE MEDIUM FOR EMBEDDING OPTIONS IN AN IMAGE PRIOR TO STORAGE

(71) Applicant: Amasing Apps USA LLC, Miami, FL (US)

(72) Inventor: Marco Valerio Masi, Paradiso (CH)

(21) Appl. No.: 14/981,082

(22) Filed: Dec. 28, 2015

(51) Int. Cl. H04N 1/21; H04N 1/32

(52) U.S. Cl. CPC H04N 1/2112; H04N 1/32149; H04N 2201/3247; H04N 2201/0084

(57) ABSTRACT

An apparatus, computer-readable medium, and method for embedding options in an image prior to storage, including capturing, by an image capture device, an image, the image being stored as a temporary file which is configured for automatic deletion upon fulfillment of one or more conditions, transmitting one or more options relating to the image prior to non-temporary storage of the image, receiving one or more user selections corresponding to at least one of the of one or more options prior to non-temporary storage of the image, transforming the image prior to non-temporary storage of the image by incorporating the one or more user selections into the temporary file, and storing the transformed image in a non-temporary file.

### BACKGROUND

Mobile phones are currently utilized as the primary image capture device for many users. However, capturing, managing, and organizing photographs through a mobile interface and through existing mobile applications can be unintuitive and unnecessarily complex for many users.

In particular, there are currently no applications which allow users to edit options relating to a captured image prior to storage of the image. As a result, many users are forced to capture and store many images and then sort through the images at a later time to add privacy settings, tags, or other options to the images and decide which images they would like to store or share.

Accordingly, alternative technologies for capturing and storing images are needed.

### BRIEF DESCRIPTION OF THE DRAWINGS

FIG. 1 illustrates a flowchart for embedding options in an image prior to storage according to an exemplary embodiment.

FIGS. 2A-2B illustrate an interface for image capture according to an exemplary embodiment.

FIG. 3 illustrates an interface for transmitting options according to an exemplary embodiment.

FIG. 4 illustrates an interface for an access control option according to an exemplary embodiment.

FIG. 5 illustrates an interface for a content tag option according to an exemplary embodiment.

FIG. 6 illustrates an interface for a temporal condition option according to an exemplary embodiment.

FIG. 7 illustrates an interface storing an image according to an exemplary embodiment.

FIG. 8 illustrates another interface for storing an image according to an exemplary embodiment.

FIG. 9 illustrates an exemplary computing environment that can be used to carry out the method for embedding options in an image prior to storage according to an exemplary embodiment.

### DETAILED DESCRIPTION

While devices, adapters, methods, apparatuses, and computer-readable media are described herein by way of examples and embodiments, those skilled in the art recognize that devices, adapters, methods, apparatuses, and computer-readable media for embedding options in an image prior to storage are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The Applicant has discovered methods and systems for embedding options in an image prior to storage. These systems and methods allow users to efficiently select and apply preferences or options to a captured image prior to initial storage of the image, thereby streamlining the image capture and storage process and saving computing resources (both in terms of disk space and processing time) on mobile devices of users.

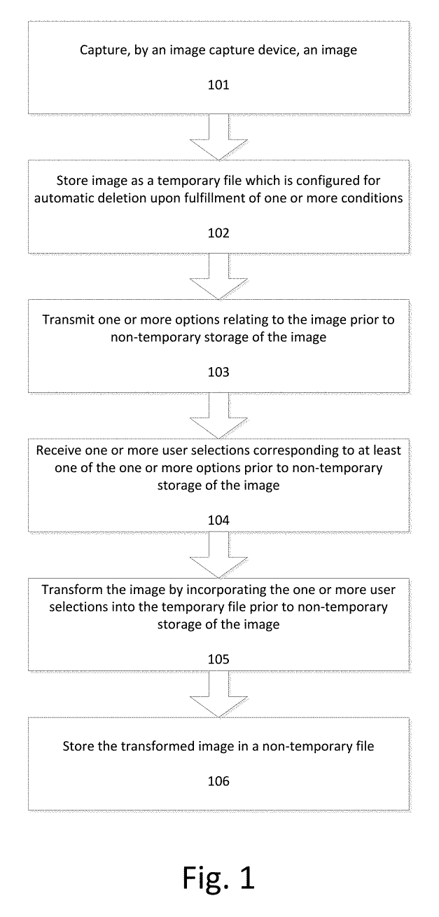

FIG. 1 illustrates a flowchart for a method for embedding options in an image prior to storage according to an exemplary embodiment. At step 101 an image is captured by an image capture device coupled to a computing device (such as a mobile computing device) executing the method.

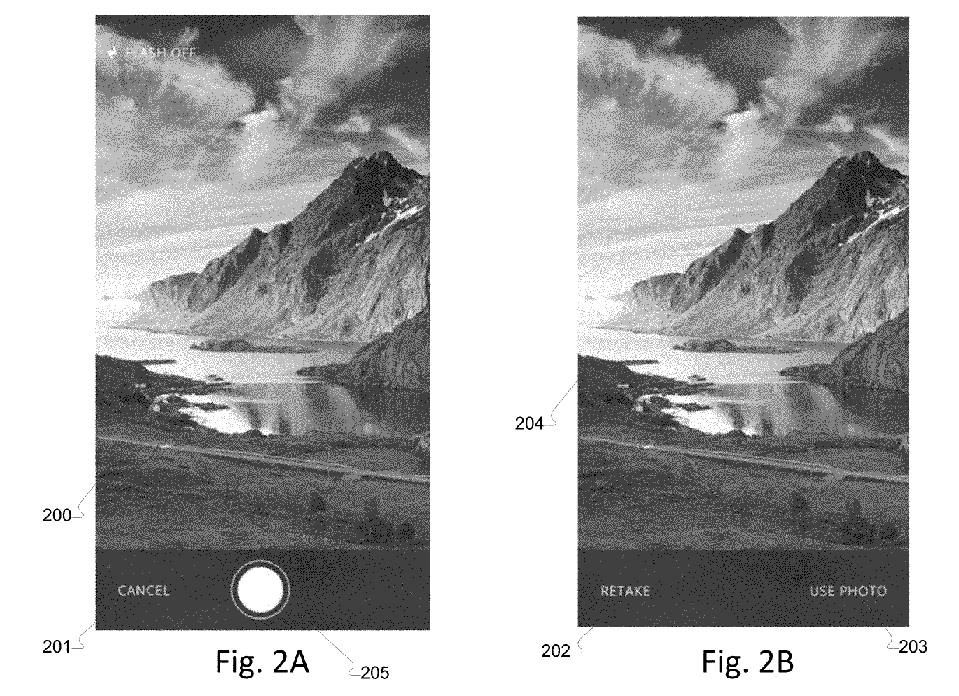

FIG. 2A illustrates an example of an interface which can be used to capture the image. As shown in FIG. 2A, the current view of the lens of the image capture device is shown as image 200 within the interface and reflects the image that would be captured if the user were to select the capture button 205. Also shown is a cancel button 201 which would close the interface shown in FIG. 2A and return the user to a different interface.

FIG. 2B illustrates an example of the image capture interface after the user has selected the capture button 205 in FIG. 2A. Image 204 is the captured image. As shown in FIG. 2B, the user can choose to capture another image by selecting the retake button 202. If the user is satisfied with the image, the user can select the use photo button 203 to proceed with this image.

Returning to FIG. 1, at step 102 the image is stored is stored as a temporary file which is configured for automatic deletion upon fulfillment of one or more conditions. The one or more conditions can include an absence of user input for a predetermined period of time, capture of a second image, storage of the image in a non-temporary file, and/or storage of a transformed version of the image in a non-temporary file. Of course, other conditions can also be utilized to determine when to delete the temporary file. For example, the temporary file can be deleted if a user locks their mobile device after image capture, if the user opens another application, if the user powers off their mobile device, and/or after a predetermined period of time in which the temporary file is not saved as a non-temporary file.

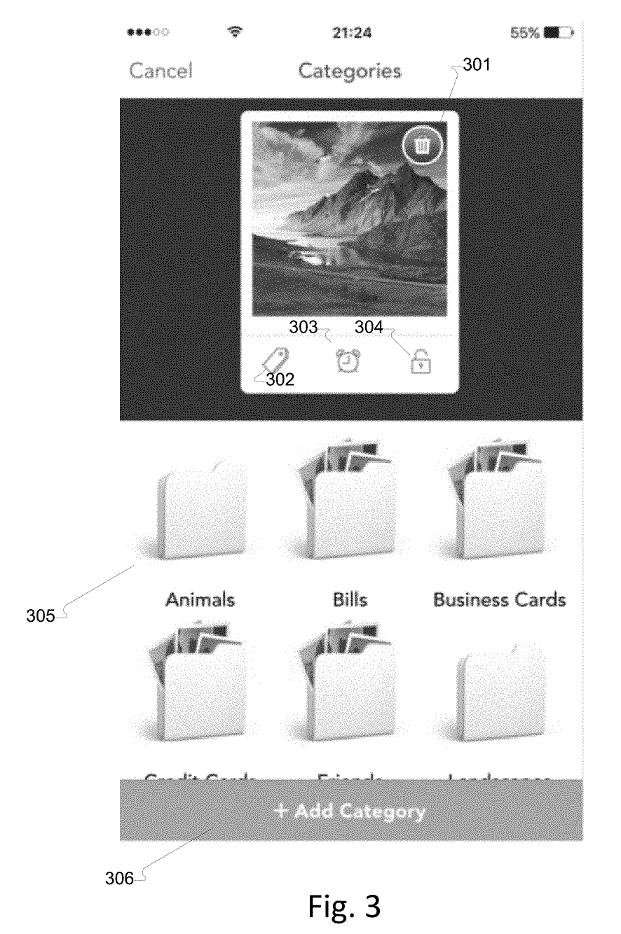

At step 103 one or more options relating to the image are transmitted prior to non-temporary storage of the image. FIG. 3 illustrates an example of an interface including one or more options relating to the image. The one or more options relating to the image can include an access control option for the image, such as lock option 304, a content tag option for the image, as content tag option 302, and/or a temporal condition option for the image, such as reminder option 303 (shown as an alarm clock). Of course, other options can also be utilized. For example, an access control option which allows a user to set permissions for an image can also be transmitted.

As shown in FIG. 3, the interface after image capture can also one or more category folders 305 which the image can be stored in (when storing the image in a non-temporary file), as well as an option to add category folders 306. If a user desires to save the image in a new category, the user can select the add category button 306, input a new category name, and the new category will appear alongside other folders 305. Additionally, the interface can include a delete button 301 which explicitly deletes the temporary file with the image. If the delete button 301 is selected, the temporary file with the image will be deleted and the image will not be saved in a non-temporary file.

Returning to FIG. 1, at step 104 one or more user selections corresponding to at least one of the one or more options are received prior to non-temporary storage of the image. As will be described later in this document, this can include selection of an access control option, an addition of one or more tags, a selection of a reminder option to add a temporal condition, or a selection of some other option.

At step 105 the image is transformed prior to non-temporary storage of the image by incorporating the one or more user selections into the temporary file. This transformation will be described in greater detail with regard to each of the options.

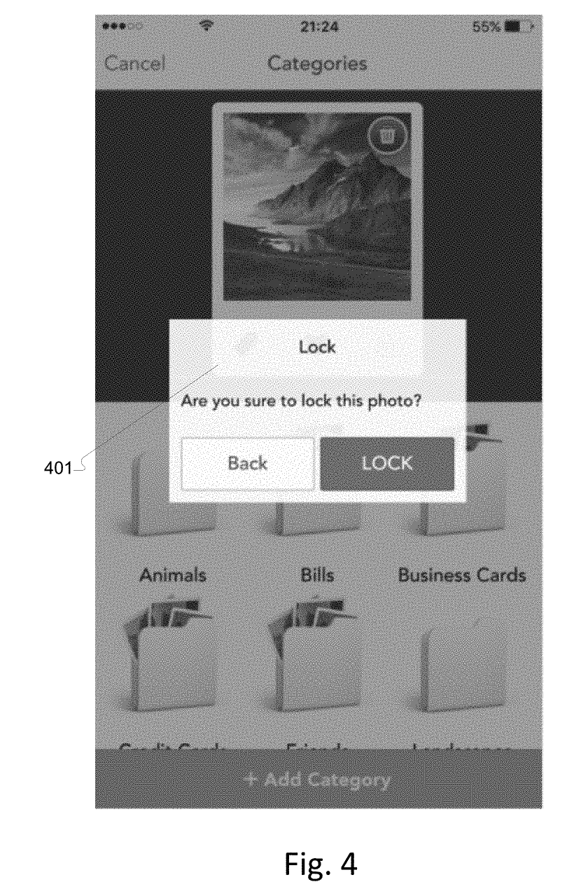

FIG. 4 illustrates an interface that can be transmitted in response to receiving a selection of a lock option which is configured to prohibit viewing of the image by other users, such as lock option 304. Of course, many different access control options are possible. As discussed earlier, a permissions option can be transmitted to the user, can be selectable by the user, and can be configured to set permissions for a particular image. Permissions can specify which users or groups (such as user-defined groups) can access an image, as well as conditions for accessing an image, such as temporal conditions associated with certain users (e.g. user A can only access the image for 2 days).

As shown in FIG. 4, pop-up window 401 can ask the user to confirm that they would like to lock a particular image. Optionally, the pop-window can be omitted and selection of the lock option can result in locking of the image without an additional confirmation step.

In the case of selection of an access control option, the step of transforming the image by incorporating the one or more user selections into the temporary file can include adding a security condition to the temporary file. The security condition can be configured to cause a computing device to authenticate a user attempting to access the temporary file. For example, if the user selects the lock option, then if any user attempts to access the image in the temporary file, they can be required to enter a password or pin to gain access to the temporary file. In the case of access control permissions, a user may be required to enter a user name or log in to an account that establishes their identify and allows the computing device to verify that the user is on the authorized users list.

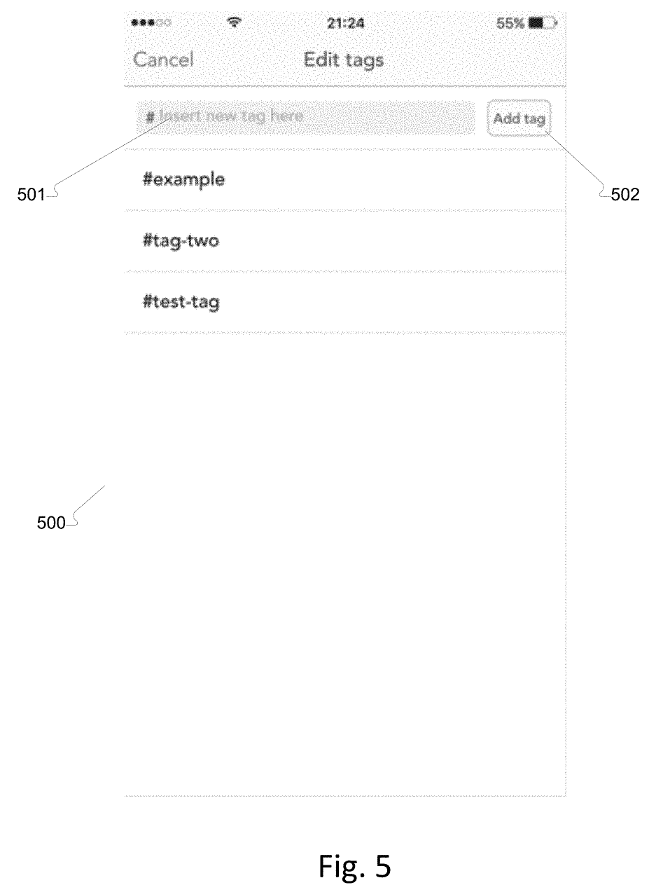

FIG. 5 illustrates an interface that can be transmitted in response to receiving a selection of a content tag option, such as content tag option 302 in FIG. 3. As shown in FIG. 5, an input window 500 can be transmitted which allows the system to receive input 501 of one or more content tags relating to the image via the input window. After the user types the tag in the input area 501, the user can select the add tag 502 to add the tag to the image.

In the case of selection of a content tag option, the step of transforming the image by incorporating the one or more user selections into the temporary file can include adding one or more metadata tags corresponding to the inputted content tags to the temporary file. Optionally, the metadata tags can be used to automatically sort the image to a particular category folder when the image is stored in a non-temporary file.

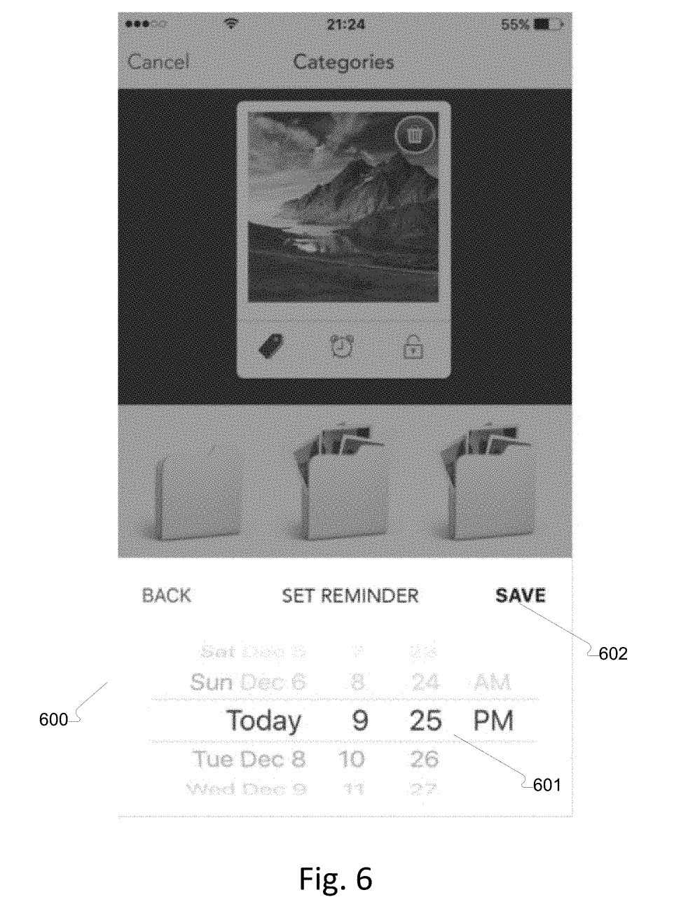

FIG. 6 illustrates an interface that can be transmitted in response to receiving a selection of the temporal condition option, such as reminder option 303 in FIG. 3. Interface 600 allows the system to receive a selection of a time and date 601 from the user. Of course, other temporal condition options can also allow a user to specify a duration, ranging anywhere from a predetermined number of seconds up to minutes, hours, days, weeks, months, or years.

In the case of selection of a temporal condition option, the step of transforming the image by incorporating the one or more user selections into the temporary file can include adding a temporal condition to the temporary file. The temporal condition can be configured to alert a computing device (such as the mobile device) at the selected time and date. The computing device can be configured to perform an action at the selected time and date. For example, if the user selects a reminder option, the temporary file of the image can be annotated with selected time and date and a flag indicating that a reminder is to be issued at that time and date. At the same time, the application used to view the image can incorporate functionality to parse image files, identify any flags in the image files, and trigger appropriate actions corresponding to the flags at the specified time and date. In another example, a user can select a temporal condition that the image is to be locked after a certain time period or on a specified time and date. This can result in the temporary file being transformed to include a flag corresponding to a lock along with the time and date (or duration and the lock command time). At the specified time and date, the application used to access captured images can then lock the file to other users as discussed previously.

Returning to FIG. 1, at step 106 the transformed image (in the form of the temporary file which has incorporated the user selections) is stored in a non-temporary file. A non-temporary file is one which is not configured for automatic deletion. As discussed earlier, the storage of the transformed image in a non-temporary file can also be one of the conditions for deletion of the temporary file. In this case, after the transformed image has been successfully stored in the non-temporary file, the temporary file can then be deleted. The non-temporary file will incorporate all of the user selections that were applied to the temporary file and resulted in the transformed image. For example, if the user applied tags, temporal conditions, and/or security conditions to the temporary file to generate the transformed image, then those user selections will carry over into the non-temporary file.

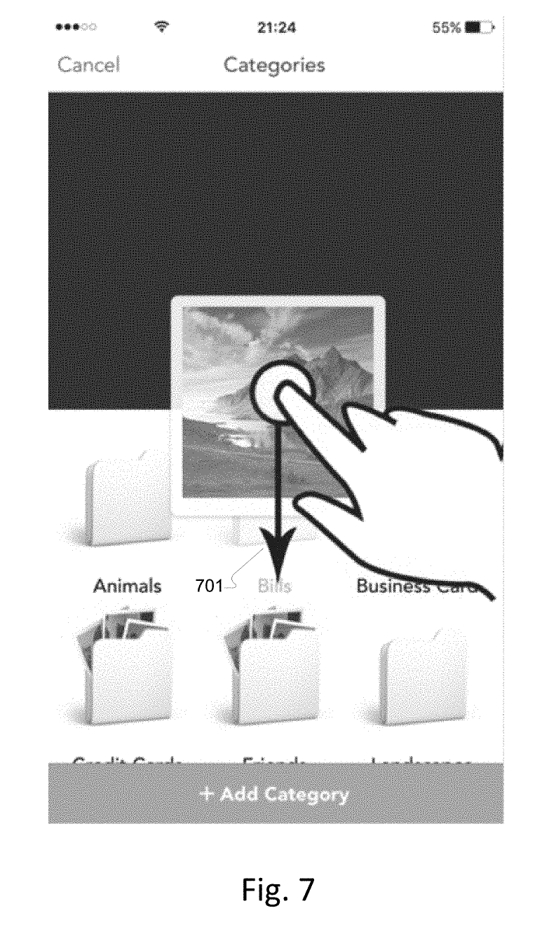

FIG. 7 illustrates an interface that can be used to save the transformed image in a non-temporary file. As shown in FIG. 7, a user can use a drag and drop gesture 701 to drag the transformed image to a particular category folder (in this case the Bills category folder).

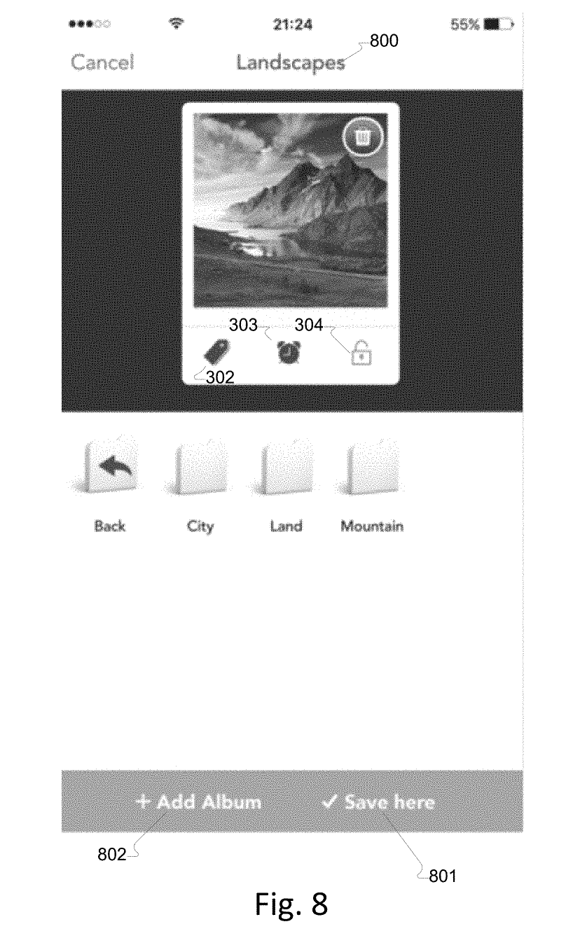

Alternatively, as shown in FIG. 8, a user can navigate to a particular category folder, such as the Landscapes 800 category folder. Once in a particular category folder, a user can select the save here button 801 to save the transformed image in that category folder. A user can also add new albums to a particular category folder by selecting the add album button 802 and then navigate to a particular album to save the transformed image in that album (or drag and drop the transformed image in a particular album). As shown in FIG. 8, the options buttons can reflect which options have been selected. For example, in FIG. 8, the user has selected the content tags option 302 and the reminder option 303 but not the lock option 304.

The category folders can correspond to folders on a computing device that is coupled to the image capture device (such as the mobile device itself) but can also correspond to folders on a cloud computing device or cloud storage which is external to the computing device that is coupled to the image capture device. In this case, since the user selections are integrated into the transformed image, there is no need to export additional files or information relating to the user selections.

Alternatively, information relating to the user selections can be stored in a separate temporary file from the temporary file which stores the captured image. When the image is transformed, this separate temporary file can then be linked to the temporary file which stores the image and the pair of linked temporary files can then be stored as one or more non-temporary files.

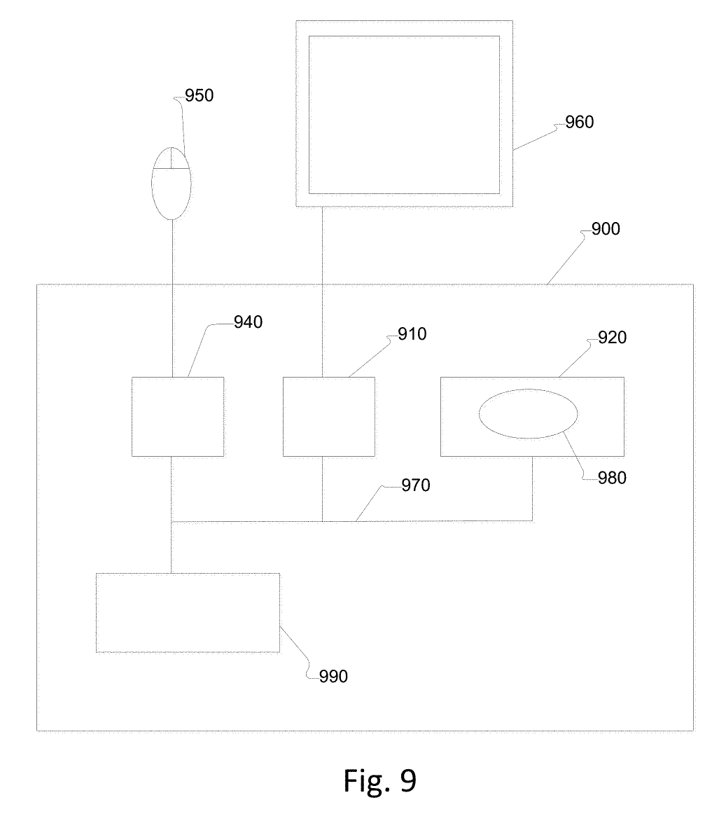

One or more of the above-described techniques can be implemented in or involve one or more computer systems. FIG. 9 illustrates a generalized example of a computing environment 900. The computing environment 900 is not intended to suggest any limitation as to scope of use or functionality of a described embodiment.

With reference to FIG. 9, the computing environment 900 can be a mobile device and includes at least one processing unit 910 and memory 920. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. The memory 920 may store software instructions 980 for implementing the described techniques when executed by one or more processors. Memory 920 can be one memory device or multiple memory devices.

A computing environment may have additional features. For example, the computing environment 900 includes storage 940, one or more input devices 950, one or more output devices 960, and one or more communication connections 990. An interconnection mechanism 970, such as a bus, controller, or network interconnects the components of the computing environment 900. Typically, operating system software or firmware (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other medium which can be used to store information and which can be accessed within the computing environment 900. The storage 940 may store instructions for the software 980.

The input device(s) 950 may be a touch input device such as a keyboard, mouse, pen, trackball, touch screen, or game controller, a voice input device, a scanning device, a digital camera, remote control, or another device that provides input to the computing environment 900. The output device(s) 960 may be a display, television, monitor, printer, speaker, or another device that provides output from the computing environment 900.

The communication connection(s) 990 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 900, computer-readable media include memory 920, storage 940, communication media, and combinations of any of the above.

Of course, FIG. 9 illustrates computing environment 900, display device 960, and input device 950 as separate devices for ease of identification only. Computing environment 900, display device 960, and input device 950 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 900 may be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for embedding options in an image prior to storage, the method comprising:
capturing, by an image capture device coupled to at least one of the one or more computing devices, an image, wherein the image is stored as a temporary file which is configured for automatic deletion upon fulfillment of one or more conditions;
transmitting, by at least one of the one or more computing devices, one or more options relating to the image prior to non-temporary storage of the image, wherein the one or more options comprise one or more of: an access control option for the image, a content tag option for the image, or a temporal condition option for the image;
receiving, by at least one of the one or more computing devices, one or more user selections corresponding to at least one of the of one or more options prior to non-temporary storage of the image;
transforming, by at least one of the one or more computing devices, the image prior to non-temporary storage of the image by incorporating the one or more user selections into the temporary file; and
storing, by at least one of the one or more computing devices, the transformed image in a non-temporary file.

2. The method of claim 1, wherein one or more conditions comprise one or more of:
an absence of user input for a predetermined period of time;
capture of a second image;
storage of the image in a non-temporary file; or
storage of the transformed image in a non-temporary file.

3. The method of claim 1, wherein the one or more options comprise an access control option for the image and wherein receiving one or more user selections corresponding to at least one of the one or more options comprises:
receiving a selection of a lock option configured to prohibit viewing of the image by other users.

4. The method of claim 3, wherein transforming the image by incorporating the one or more user selections into the temporary file comprises:
adding a security condition to the temporary file, wherein the security condition is configured to cause a computing device to authenticate a user attempting to access the temporary file.

5. The method of claim 1, wherein the one or more options comprise a content tag option for the image and wherein receiving one or more user selections corresponding to at least one of the one or more options comprises:
receiving a selection of the content tag option;
transmitting an input window; and
receiving input of one or more content tags relating to the image via the input window.

6. The method of claim 1, wherein the one or more options comprise a temporal condition option for the image and wherein receiving one or more user selections corresponding to at least one of the one or more options comprises:
receiving a selection of the temporal condition option; and
receiving a selection of a time and date.

7. The method of claim 6, wherein transforming the image by incorporating the one or more user selections into the temporary file comprises:
adding a temporal condition to the temporary file, wherein the temporal condition is configured to alert at least one of the one or more computing devices at the selected time and date and wherein at least one of the one or more computing devices is configured to perform an action at the selected time and date.

8. The method of claim 1, wherein the non-temporary file is stored in a cloud computing device external to the one or more computing devices.

9. An apparatus for embedding options in an image prior to storage, the apparatus comprising:
one or more processors; and
one or more memories operatively coupled to at least one of the one or more processors and having instructions stored thereon that, when executed by at least one of the one or more processors, cause at least one of the one or more processors to:
capture, by an image capture device coupled to the apparatus, an image, wherein the image is stored as a temporary file which is configured for automatic deletion upon fulfillment of one or more conditions;
transmit one or more options relating to the image prior to non-temporary storage of the image, wherein the one or more options comprise one or more of: an access control option for the image, a content tag option for the image, or a temporal condition option for the image;
receive one or more user selections corresponding to at least one of the of one or more options prior to non-temporary storage of the image;
transform the image prior to non-temporary storage of the image by incorporating the one or more user selections into the temporary file; and
store the transformed image in a non-temporary file.

10. The apparatus of claim 9, wherein one or more conditions comprise one or more of:
an absence of user input for a predetermined period of time;
capture of a second image;
storage of the image in a non-temporary file; or
storage of the transformed image in a non-temporary file.

11. The apparatus of claim 9, wherein the one or more options comprise an access control option for the image and wherein the instructions that, when executed by at least one of the one or more processors, cause at least one of the one or more processors to receive one or more user selections corresponding to at least one of the one or more options further cause at least one of the one or more processors to:
receive a selection of a lock option configured to prohibit viewing of the image by other users.

12. The apparatus of claim 11, wherein the instructions that, when executed by at least one of the one or more processors, cause at least one of the one or more processors to transform the image by incorporating the one or more user selections into the temporary file further cause at least one of the one or more processors to:
add a security condition to the temporary file, wherein the security condition is configured to cause a computing device to authenticate a user attempting to access the temporary file.

13. The apparatus of claim 9, wherein the one or more options comprise a content tag option for the image and wherein the instructions that, when executed by at least one of the one or more processors, cause at least one of the one or more processors to receive one or more user selections corresponding to at least one of the one or more options further cause at least one of the one or more processors to:
receive a selection of the content tag option;
transmit an input window; and
receive input of one or more content tags relating to the image via the input window.

14. The apparatus of claim 9, wherein the one or more options comprise a temporal condition option for the image and wherein the instructions that, when executed by at least one of the one or more processors, cause at least one of the one or more processors to receive one or more user selections corresponding to at least one of the one or more options further cause at least one of the one or more processors to:
receive a selection of the temporal condition option; and
receive a selection of a time and date.

15. The apparatus of claim 14, wherein the instructions that, when executed by at least one of the one or more processors, cause at least one of the one or more processors to transform the image by incorporating the one or more user selections into the temporary file further cause at least one of the one or more processors to:
add a temporal condition to the temporary file, wherein the temporal condition is configured to alert at least one of the one or more computing devices at the selected time and date and wherein at least one of the one or more computing devices is configured to perform an action at the selected time and date.

16. The apparatus of claim 9, wherein the non-temporary file is stored in a cloud computing device external to the one or more computing devices.

17. At least one non-transitory computer-readable medium storing computer-readable instructions that, when executed by one or more computing devices, cause at least one of the one or more computing devices to:
capture, by an image capture device coupled to at least one of the one or more computing devices, an image, wherein the image is stored as a temporary file which is configured for automatic deletion upon fulfillment of one or more conditions;
transmit one or more options relating to the image prior to non-temporary storage of the image, wherein the one or more options comprise one or more of: an access control option for the image, a content tag option for the image, or a temporal condition option for the image;
receive one or more user selections corresponding to at least one of the of one or more options prior to non-temporary storage of the image;
transform the image prior to non-temporary storage of the image by incorporating the one or more user selections into the temporary file; and
store the transformed image in a non-temporary file.

18. The at least one non-transitory computer-readable medium of claim 17, wherein one or more conditions comprise one or more of:
an absence of user input for a predetermined period of time;
capture of a second image;
storage of the image in a non-temporary file; or
storage of the transformed image in a non-temporary file.

19. The at least one non-transitory computer-readable medium of claim 17, wherein the one or more options comprise an access control option for the image and wherein the instructions that, when executed by at least one of the one or more computing devices, cause at least one of the one or more computing devices to receive one or more user selections corresponding to at least one of the one or more options further cause at least one of the one or more computing devices to:
receive a selection of a lock option configured to prohibit viewing of the image by other users.

20. The at least one non-transitory computer-readable medium of claim 19, wherein the instructions that, when executed by at least one of the one or more computing devices, cause at least one of the one or more computing devices to transform the image by incorporating the one or more user selections into the temporary file further cause at least one of the one or more computing devices to:
add a security condition to the temporary file, wherein the security condition is configured to cause a computing device to authenticate a user attempting to access the temporary file.

21. The at least one non-transitory computer-readable medium of claim 17, wherein the one or more options comprise a content tag option for the image and wherein the instructions that, when executed by at least one of the one or more computing devices, cause at least one of the one or more computing devices to receive one or more user selections corresponding to at least one of the one or more options further cause at least one of the one or more computing devices to:
receive a selection of the content tag option;
transmit an input window; and
receive input of one or more content tags relating to the image via the input window.

22. The at least one non-transitory computer-readable medium of claim 17, wherein the one or more options comprise a temporal condition option for the image and wherein the instructions that, when executed by at least one of the one or more computing devices, cause at least one of the one or more computing devices to receive one or more user selections corresponding to at least one of the one or more options further cause at least one of the one or more computing devices to:
receive a selection of the temporal condition option; and
receive a selection of a time and date.

23. The at least one non-transitory computer-readable medium of claim 22, wherein the instructions that, when executed by at least one of the one or more computing devices, cause at least one of the one or more computing devices to transform the image by incorporating the one or more user selections into the temporary file further cause at least one of the one or more computing devices to:
add a temporal condition to the temporary file, wherein the temporal condition is configured to alert at least one of the one or more computing devices at the selected time and date and wherein at least one of the one or more computing devices is configured to perform an action at the selected time and date.

24. The at least one non-transitory computer-readable medium of claim 17, wherein the non-temporary file is stored in a cloud computing device external to the one or more computing devices.
